(19) United States
(12) Patent Application Publication
(10) Pub. No.: US 2006/0272001 A1
(43) Pub. Date: Nov. 30, 2006

(54) AV device and method of controlling the same

(75) Inventors: Akira Miyazawa, Saitama-shi (JP); Takahiro Kimura, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/443,211

(22) Filed: May 31, 2006

(30) Foreign Application Priority Data
May 31, 2005 (JP) 2005-160611

(51) Int. Cl. H04N 7/16

(52) U.S. Cl. 725/139

(57) ABSTRACT

According to one embodiment, a plurality of device including an AV device are connected to a network, and the AV device is caused to select a device targeted for control. When the selected device is an external device instead of the AV device itself, information indicating commands capable of controlling the selected device is selected from the device, and the acquired commands are assigned to keys of a remote controller. In this manner, the selected device can be controlled by operating the keys of the remote controller.

### CROSS-REFERENCE TO RELATED APPLICATIONS

This application is based upon and claims the benefit of priority from Japanese Patent Application No. 2005-160611, filed May 31, 2005, the entire contents of which are incorporated herein by reference.

### BACKGROUND

1. Field

The present invention relates to an audio video (AV) device which selectively controls a plurality of devices connected to a network, and a method of controlling the AV device.

2. Description of the Related Art

As is well known, in recent years, it has been possible to construct a network system by connecting a variety of devices including, for example, a television (TV) receiver, a set top box (STB), a digital versatile disk (DVD) recorder, and a personal computer (PC) via a predetermined digital interface such as i. Link (registered trademark).

In the network system of this type, a specific device is selected by using an AV device having a video display panel, and an operation screen relevant to the selected device is displayed as an on-screen display (OSD) on the video display panel, whereby the specific device can be controlled on the operation screen.

However, in general, it is necessary to display an operation screen every time control is made, in order to control a specific device connected to a network by using an operation screen OSD-displayed on a video display panel. In addition, operation itself is complicated, and thus, user's handling becomes inconvenient.

Jpn. Pat. Appln. KOKAI Publication No. 2002-41210 discloses a configuration of a device control apparatus for acquiring control information from a device targeted for control over a network, thereby making it possible to control a plurality of devices targeted for control by one apparatus, the control apparatus using buttons featured in that, if an external pressure is applied, comfortable operation can be made by generating a physical stroke in order to make an operation for make that control.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram depicting one embodiment of the present invention, the block diagram being adopted to explain a recording and replay apparatus;

FIG. 2 is a view adopted to explain an external view of a remote controller of the recording and replay apparatus in the present embodiment;

FIG. 3 is a flow chart adopted to explain an example of a command assigning processing operation of the recording and replay apparatus in the present embodiment;

FIG. 4 is a view adopted to explain an example of a menu screen displayed at the time of the command assigning processing operation of the recording and replay apparatus in the present embodiment;

FIG. 5 is a view adopted to explain an example of a device selection screen displayed at the time of the command assigning processing operation of the recording and replay apparatus in the present embodiment;

FIG. 6 is a flow chart adopted to explain an example of a command assignment display processing operation of the recording and replay apparatus in the present embodiment;

FIG. 7 is a view adopted to explain an example of a command assignment screen displayed at the time of the command assignment display processing operation of the recording and replay apparatus in the present embodiment; and

FIG. 8 is a flow chart adopted to explain another example of the command assigning processing operation of the recording and replay apparatus in the present embodiment.

### DETAILED DESCRIPTION

Various embodiments according to the invention will be described hereinafter with reference to the accompanying drawings. In general, according to one embodiment of the invention, a plurality of device including an AV device are connected to a network, and the AV device is caused to select a device targeted for control. When the selected device is an external device instead of the AV device itself, information indicating commands capable of controlling the selected device is selected from the device, and the acquired commands are assigned to keys of a remote controller. In this manner, the selected device can be controlled by operating the keys of the remote controller.

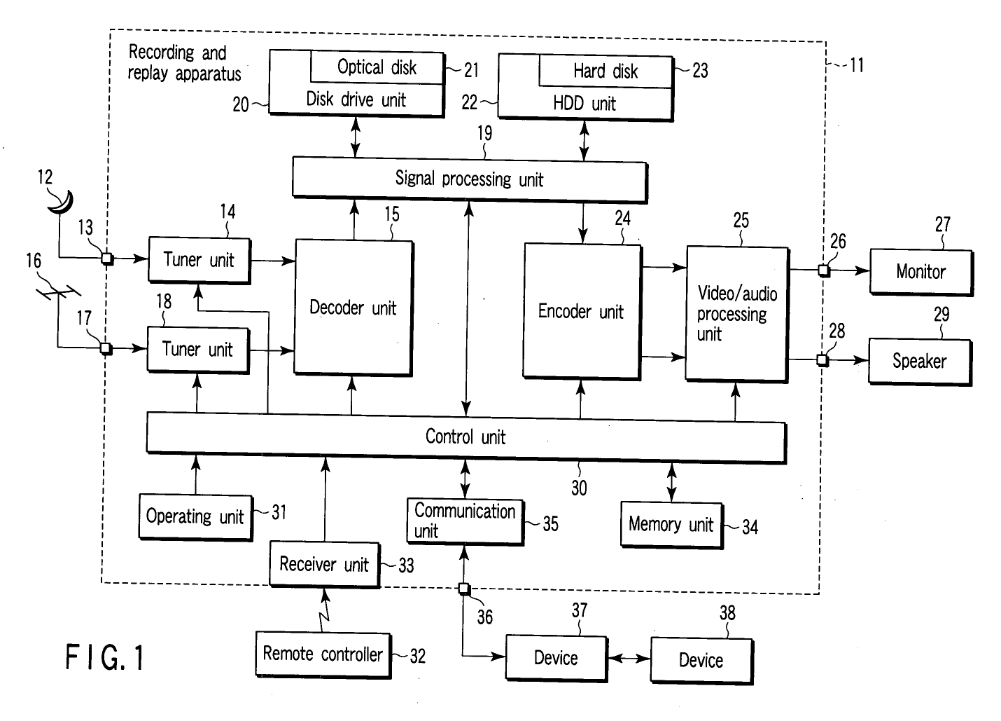

FIG. 1 shows a recording and replay apparatus 11 serving as an AV device to be described in this embodiment. That is, a broadcast signal received by an antenna 12 for receiving a satellite broadcast is supplied to a tuner unit 14 via an input terminal 13, the supplied signal is subjected to a channel selection process and a demodulation process, and the resultant signal is supplied to a decoder unit 15.

In addition, a broadcast signal received by an antenna 16 for receiving a terrestrial broadcast is supplied to a tuner unit 18 via an input terminal 17, the supplied signal is subjected to-a channel selection process and a demodulation process, and the resultant signal is supplied to the decoder unit 15.

The decoder unit 15 selectively applies a decoding process to the signal supplied from each of the tuner units 14 and 18. The decoded signal by the decoder unit 15 is provided to be recorded into an optical disk 21 using a disk drive unit 20 and to be recorded into a hard disk 23 using a hard disk drive (HDD) unit 22 via a signal processing unit 19. Recording of the signal into the optical disk 21 and recording of the signal into the hard disk 23 can be selectively carried out or can be carried out at the same time.

On the other hand, the signal recorded in the optical disk 21 is read at the disk drive unit 20, and the read signal is supplied to the signal processing unit 19. In addition, the signal recorded in the hard disk 23 is read by the HDD section 22, and the read signal is supplied to the signal processing unit 19. The signal processing unit 19 supplies the signal supplied from the disk drive unit 20 or the HDD section 22 to an encoder unit 24.

The encoder unit 24 applies an encoding process to the signal supplied from the signal processing unit 19, and generates a video signal and an audio signal. Then, the video signal generated by the encoder unit 24 is subjected to a predetermined video signal processing by a video/audio processing unit 25, and then provided for video display on an external monitor 27 via an output terminal 26.

The audio signal generated by the encoder unit 24 is subjected to a predetermined audio signal processing by the video/audio processing unit 25, and then provided for audio replay by an external speaker 29 via an output terminal 28.

Here, the recording and replay apparatus 11 integrally controls all operations including the above-described recording and replay operations by a control unit 30. The control unit 30 incorporates a central processing unit (CPU) and the like, and controls each unit such that the operation contents are reflected by receiving operation information from an operating unit 31 or operation information transmitted from a remote controller 32 via a receiver unit 33.

In this case, the control unit 30 utilizes a memory unit 34. The memory unit 34 primarily comprises: a read only memory (ROM) having stored therein a control program executed by the CPU; a random access memory (RAM) for providing a work area to the CPU; and a nonvolatile memory in which a variety of setting information and control information, etc. are stored.

Further, the control unit 30 is connected to a connector terminal 36 via a communication unit 35 that conforms to a digital interface standard such as, for example, i. Link (registered trademark). A variety of devices 37 and 38 (two devices shown) including, for example, a TV receiver, an STB, a DVD recorder, and a PC are connected to the connector terminal 36 via a network.

Then, the above control unit 30 makes communication with each of the devices 37 and 38 via the communication unit 35 so that a desired device can be selectively controlled.

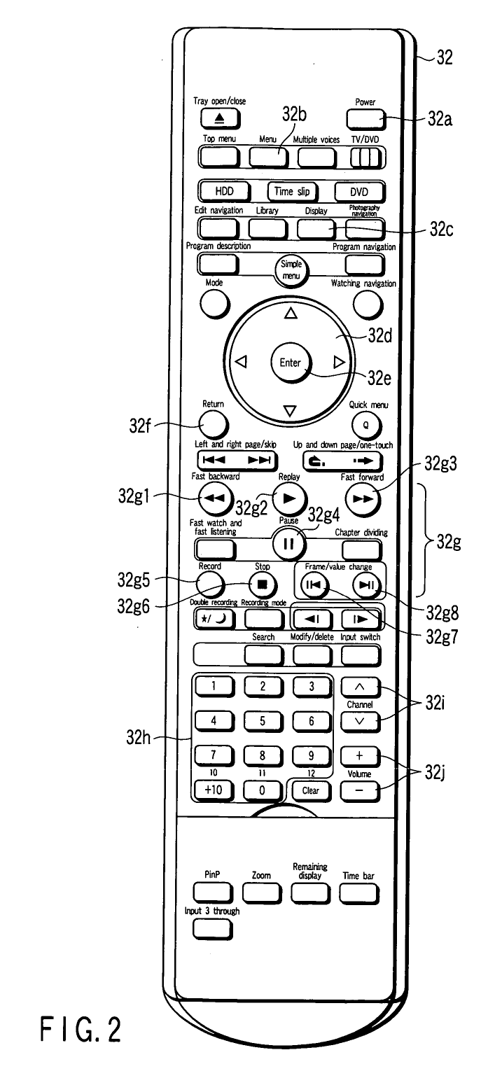

FIG. 2 shows an external view of the above remote controller 32. The remote controller 32 is primarily provided with a power supply key 32a, a menu key 32b, a display key 32c, a cursor key 32d, an enter key 32e, a return key 32f, keys 32g relating to recording and replay control (a fast backward key 32g1, a replay key 32g2, a fast forward key 32g3, a pause key 32g4, a recording key 32g5, a stop key 32g6, a frame backward key 32g7, a frame forward key 32g8), numeric keys 32h, channel up/down keys 32i, a volume control key 32j, and the like.

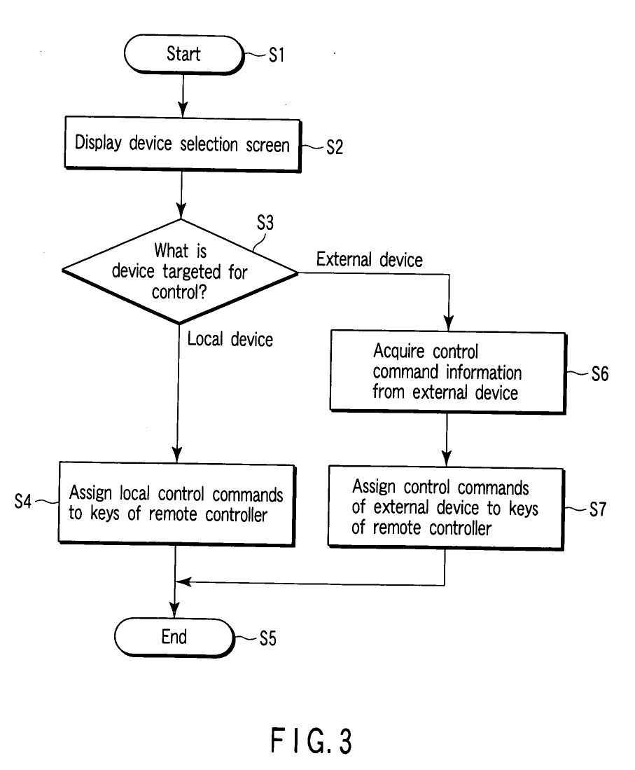

FIG. 3 shows a flow chart for explaining an example of a processing operation in the case where the recording and replay apparatus 11 selects and controls a desired device from among the variety of devices 37 and 38 (including the recording and replay apparatus 11 itself) connected to a network.

This processing is started (block S1) in such a manner that a user makes an operation for requesting a selection of a desired device to be controlled, from among the variety of devices 37 and 38 (including the recording and replay apparatus 11 itself) connected to a network. Then, the control unit 30 causes a monitor 27 to display a device selection screen in block S2.

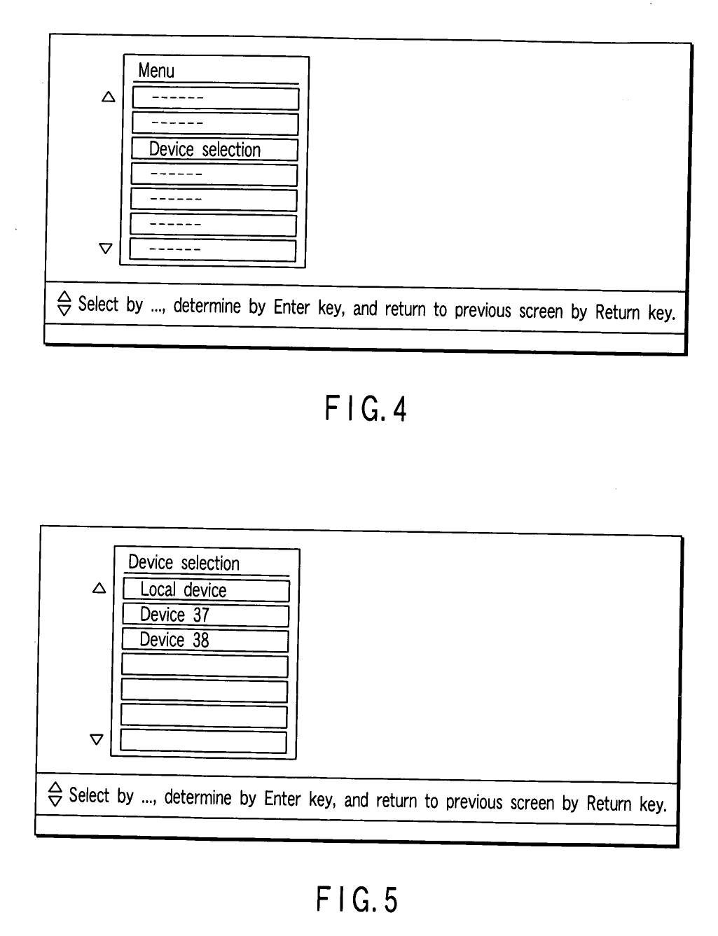

That is, when the user operates the menu key 32b of the remote controller 32, the control unit 30 causes the monitor 27 to display a menu screen on which a variety of selection items have been arranged, as shown in FIG. 4.

Then, when the user selects an item “device selection) by the cursor key 32c from among the variety of items displayed on the menu screen, and operates the enter key 32d, the control unit 30 acquires information indicating device types (such as HDD, D (digital)—VHS (video home system), and tuner) from each of all the devices 37 and 38 connected to a network, and stores the acquired information in the nonvolatile memory of the memory unit 34.

Then, the control unit 30 causes the monitor 27 to display a device selection screen indicating a list of all the devices 37 and 38 currently connected to a network, as shown in FIG. 5, with reference to the contents of the nonvolatile memory. On the device selection screen, a local device, namely, the recording and replay apparatus 1 itself is also included as a selection target. Then, on the device selection screen, the user operates the cursor key 32c, selects a desired device, and operates the enter key 32d, whereby the user can select and set any one of the devices including such a local device.

Thereafter, in block S3, the control unit 30 discriminates whether the selected and set device targeted for control is local or either of the external devices 37 and 38. Then, when it has been determined that the selected and set device targeted for control is local, the control unit 30 assigns commands for control the local device to the keys of the remote controller 32 in block S4, and terminates processing (block S5). In this manner, by operating the keys of the remote controller 32, the recording and replay apparatus 11 can be directly controlled.

When it has been determined that the device targeted for control is an external device (for example, device 37) in the block S3, the control unit 30 acquires information indicating commands (such as replay, fast forward, and frame forward, for example) that can be controlled from the device 37 targeted for control in block S6.

Thereafter, in block S7, the control unit 30 assigns commands for controlling the device 37 targeted for control to the keys of the remote controller 32, based on the information acquired in block S6, and terminates processing (block S5).

In assigning the commands to the keys of the remote controller 32, the number of keys of the remote controller 32 may not coincide with the number of commands that can be controlled. Thus, the commands to be assigned to the keys of the remote controller 32 are determined in advance. When these commands exist in the external device 37 to be controlled, assignment is carried out. If not, pausing is carried out. In the case where commands overflowed from key assignment exist, these commands are sequentially assigned to the pause key. In this manner, the device 37 targeted for control can then be directly controlled by operating the keys of the remote controller 32.

Information indicating a device type of the device 37 selected as the device targeted for control; information indicating commands that can be controlled by the device 37; and information indicating an assignment state of the commands to the keys of the remote controller 32 are maintained to be associated with each other in the nonvolatile memory of the memory unit 34.

Consequently, in the case where a next identical device 37 has been selected as a device targeted for control, commands for controlling the selected device 37 can be easily assigned to the keys of the remote controller 32 by referring to the contents of the nonvolatile memory, even if information indicating controllable commands is not acquired from that device 37.

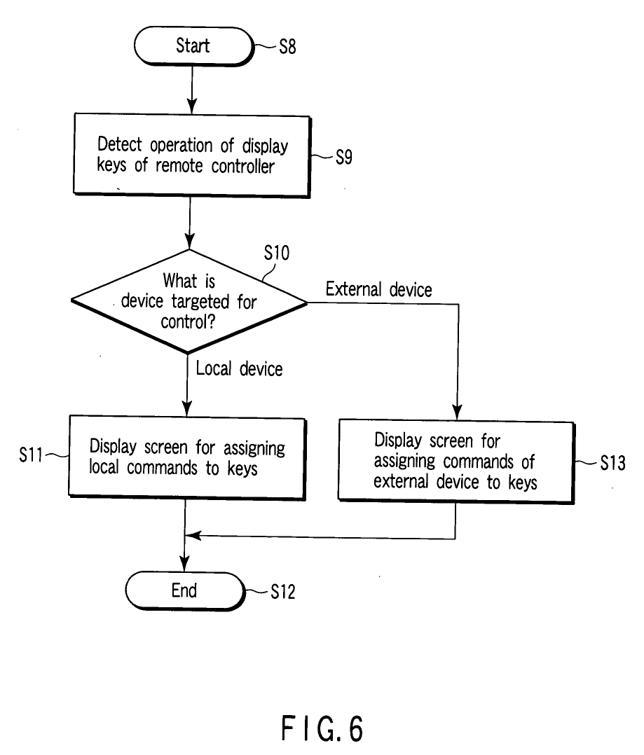

FIG. 6 shows a flow chart for explaining an example of a processing operation for displaying on a user's device what control contents are assigned to which keys in a state in which assignment of the commands for controlling the device 37 targeted for control to the keys of the remote controller 32 has terminated as described above.

That is, a processing operation is started (block S8). When the control unit 30 senses that the display key 32c of the remote controller 32 has been operated in block S9, the control unit 30 discriminates whether the device targeted for control is local or either of the external devices 37 and 38 in block S10.

In the case where it has been determined that the device targeted for control is local, the control unit 30 causes the monitor 27 to display an assignment screen indicating how the commands for controlling the local device have been assigned to the keys of the remote controller 32 in block S11, and terminates processing (block S12).

However, in the case where the device targeted for control is local, respective command names are described for the keys of the remote controller 32, namely, commands for the keys are already displayed, and thus, the processing operation of block S11 can be omitted.

When it has been determined that the device targeted for control is an external device (for example, device 37) in the block S10, the control unit 30 causes the monitor 27 to display an assignment screen indicating how the commands for controlling the external device 37 have been assigned to the keys of the remote controller 32 in block S13, and terminates processing (block S12).

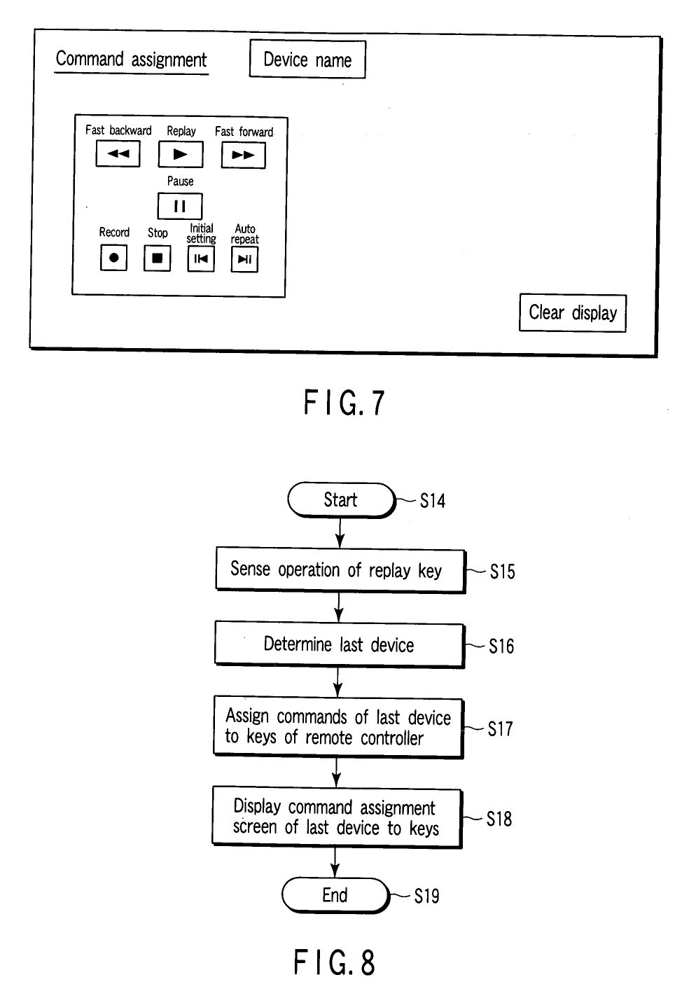

FIG. 7 shows an example of a command assignment screen displayed on the monitor 27 based on the processing operation in the block S13. The command assignment screen displays a device name indicating the device 37 targeted for control and key arrangement of the keys 32g1 to 32g8 of the keys 32g relating to recording and replay control of the remote controller 32.

Then, the commands assigned respectively are displayed for the keys displayed on the key arrangement. In this case, the essential commands, namely, command names identical to fast backward, replay, fast forward, pausing, recording, and stop are displayed for the keys displayed in association with the fast backward key 32g1, the replay key 32g2, the fast forward key 32g3, the pause key 32g4, the record key 32g5, and the stop key 32g6. Further, command names indicating initial setting and auto repeat are displayed, respectively, for the keys displayed in association with the frame backward key 32g7 and the frame forward key 32g8.

Thus, when the use operates the frame backward key 32g7 of the remote controller 32, the device 37 is controlled so as to execute an initial setting function. When the user operates the frame forward key 32g8 of the remote controller 32, the device 37 is controlled so as to execute an auto repeat function for repeatedly replaying a predetermined interval.

According to the above-described embodiment, in the case where the external device 37 has been specified as a device targeted for control, information indicating controllable commands is acquired from the device 37 targeted for control so as to assign commands for controlling the device 37 targeted for control, to the keys of the remote controller 32.

Consequently, the device 37 targeted for control can be directly controlled by operating the keys of the remote controller 32. Moreover, control relevant to a variety of devices connected to a network can be achieved by easy operation, and the user's handling can be made convenient.

FIG. 8 shows a flow chart for explaining another example of the processing operation. That is, when a processing is started (block S14), and the control unit 30 detects that, for example, the replay key 32g2 of the remote controller 32 has been operated in block S15, the control unit 30 determines which of the devices (last device) has been lastly controlled in block S16.

In the determination of the last device, identification information on the last device is maintained in the nonvolatile memory of the memory unit 34 at a time point at which control of the last device has been stopped. Therefore, the last device can be easily identified by referring to the contents of the nonvolatile memory.

Here, commands from the last device have been assigned to the keys of the remote controller 32 when the last device has been previously controlled, and information indicating such assignment is stored in the nonvolatile memory. Thus, in block S17, the control unit 30 assigns the commands for controlling the last device to the keys of the remote controller 32 based on the contents of the nonvolatile memory and controls the last device to enter a replay state.

Then, in block S18, the control unit 30 causes the monitor 27 to display an assignment screen indicating how the commands for controlling the last device have been assigned to the keys of the remote controller 32, and terminates processing (block S19).

According to the example of the processing shown in FIG. 8, the user operates the replay key 32g2, whereby a last device is automatically selected, and the commands from that last device are assigned to the keys of the remote controller 32. Consequently, for example, when a routinely identical device is frequently used, there is no need for an operation for device selection, and the user's handling can be made convenient.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An AV device which selectively controls a plurality of devices connected to a network and which is configured to be controlled by a remote controller, the AV device comprising:
a selector section configured to select a device targeted for control from said plurality of devices connected to the network including the AV device;
a first discriminating unit configured to discriminate whether the device selected by the selector section is the AV device itself or an external device;
a first assigning unit configured to, when the first discriminating unit has discriminated that the selected device is the AV device itself, assign commands for controlling the AV device to keys of the remote controller, and operate the keys of the remote controller, thereby controlling the AV device;
an acquiring unit configured to, when the first discriminating unit has discriminated that the selected device is an external device, acquire information indicating commands capable of controlling the discriminated device from the external device; and
a second assigning unit configured to control the device by assigning the commands acquired by the acquiring unit to the keys of the remote controller and operating the keys of the remote controller.

2. An AV device according to claim 1, further comprising:
a second discriminating unit configured to discriminate whether a device targeted for control is the AV device itself or an external device based on a display request; and
a first display control unit configured to, when the second discriminating unit has discriminated that the selected device is an external device, display assignment of the commands to the keys of the remote controller by the second assigning unit.

3. An AV device according to claim 1, further comprising:
a storage section configured to store an assignment state of the commands to the keys of the remote controller.

4. An AV device according to claim 3, further comprising:
a third discriminating unit configured to discriminate a lastly controlled last device from among said plurality of devices connected to the network including the AV device, based on operation of a predetermined key of the remote controller; and
a third assigning unit configured to assign commands of the last device discriminated by the third discriminating unit to the keys of the remote controller by referring to the assignment state stored in the storage section.

5. An AV device according to claim 4, further comprising:
a second display control unit configured to display assignments of the commands to the keys of the remote controller by the third assigning unit.

6. A method of controlling an AV device which selectively controls a plurality of devices connected to a network and which is configured to be controlled by a remote controller, the control method comprising:
a selection block of selecting a device targeted for control from said plurality of devices connected to the network including the AV device;
a first discriminating block of determining whether the device selected in the selection block is the AV device itself or an external device;
a first assigning block of, when it has been discriminated that the selected device is the AV device itself in the first discriminating block, assigning commands for controlling the AV device to keys of the remote controller, and operating the keys of the remote controller, thereby controlling the AV device;
an acquiring block of, when it has been discriminated that the target device is an external device in the first discriminating block, acquiring information indicating commands capable of controlling the acquired device from among the device; and
a second assigning block of assigning the commands acquired in the acquiring block to the keys of the remote controller, and operating the keys of the remote controller, thereby controlling the device.

7. An AV device control method according to claim 6, further comprising:
a second discriminating block of discriminating whether a device targeted for control is the AV device itself or an external device based on a display request; and
a first display control block of, when it has been discriminated that the target device is an external device in the second discriminating block, displaying assignments of the commands to the keys of the remote controller in accordance with the second assigning block.

8. A method of controlling an AV device, according to claim 6, further comprising:
a storage block of storing an assignment state of the commands to the keys of the remote controller.

9. A method of controlling an AV device, according to claim 8, further comprising:
a third discriminating block of discriminating a lastly controlled last device from among said plurality of devices connected to the network including the AV device, based on operation of a predetermined key of the remote controller; and
a third assigning block of assigning commands of the last device discriminated in the third discriminating block to the keys of the remote controller by referring to the assignment state stored in the storage block.

10. A method of controlling an AV device, according to claim 9, further comprising:
a second display control block of displaying assignments of the commands to the keys of the remote controller in accordance with the third assigning block.
